(19) United States
(12) Patent Application Publication
(10) Pub. No.: US 2005/0224527 A1
(43) Pub. Date: Oct. 13, 2005

(54) Squeeze bottle for viscous material

(76) Inventor: Won-Seo Pang, Deajoen (KR)

Correspondence Address: PARK & SUTTON LLP, 3255 WILSHIRE BLVD, SUITE 1110, LOS ANGELES, CA, 90010, US

(21) Appl. No.: 10/513,126

(22) PCT Filed: Jun. 18, 2003
(86) PCT No.: PCT/KR03/01189

§ 371 Date: Nov. 1, 2004

(30) Foreign Application Priority Data
May 19, 2003 (KR) 20-2003-0015328

(51) Int. Cl. B67D 3/00

(52) U.S. Cl. 222/482

(57) ABSTRACT

Disclosed is a bottle for extruding a fluid seasoning, in which the fluid seasoning such as soy source, thick soy paste mixed with red pepper, tomato ketchup, various sources, etc. stored in a bottle is extruded via an extruding pipe when the bottle is pressed, and more particularly to a bottle for extruding a fluid seasoning, in which the fluid seasoning is smoothly extruded via an extruding pipe by pressing a designated position of the bottle by hands, and then the pressed position is returned to its original state by releasing hands from the bottle so that the bottle is easily repressed. Further, the residue of the seasoning in the bottle is collected by the lower end of a discharging pipe so that the residue is easily discharged.

### TECHNICAL FIELD

The present invention relates to a bottle for extruding a fluid seasoning, in which the fluid seasoning such as soy source, thick soy paste mixed with red pepper, tomato ketchup, various sources, etc. stored in a bottle is extruded via an extruding pipe when the bottle is pressed, and more particularly to a bottle for extruding a fluid seasoning, in which the fluid seasoning is smoothly extruded via an extruding pipe by pressing a designated position of the bottle by hands, and then the pressed position is returned to its original state by releasing hands from the bottle so that the bottle is easily repressed. Further, the residue of the seasoning in the bottle is collected by the lower end of a discharging pipe so that the residue is easily discharged.

### BACKGROUND ART

Generally, when a bottle for extruding a fluid seasoning is gripped and pressed by user's hands, the fluid seasoning is discharged into an extruding pipe, and when the force of the hands is released from the bottle, external air flows into the bottle so that the bottle is swollen by its own restoring force.

However, since such a conventional bottle for extruding the fluid seasoning is made of a thermoplastic synthetic resin with poor elastically restoring force such as polyethylene, polypropylene, etc., the bottle is easily deformed by being pressed it by hands, but cannot be easily restored its original state.

That is, the fluid seasoning pressingly stored in the extruding pipe and the external air are not sucked into the inside of the bottle due to the poor elastically restoring force of the bottle itself. Accordingly, when the bottle is erected on a table for quite a time, the seasoning in the extruding pipe flows toward the bottle and at this time the external air flows into the bottle via the extruding pipe, thus swelling the bottle to its original state.

While the inside of the extruding pipe is filled with the seasoning, the bottle cannot be easily swollen and is wrinkly compressed on the table, thus making an ill appearance. Such as phenomenon is severer in a bottle containing a seasoning with high viscosity such as ketchup or mayonnaise.

Since extruded air cannot flow into the bottle under the condition that the bottle is not completely swollen as described above, there is a problem in waiting the complete swelling of the bottle. During the complete swelling of the bottle, the seasoning entered into the upper portion of the extruding pipe is pushed into the inside of the bottle by the introduced air, and the inside of the extruding pipe is vacant. In this case, when the bottle is extruded again, the bottle must be excessively or repeatedly pressed so that the vacant inside of the extruding pipe is filled with the seasoning. Accordingly, it is difficult to control the amount of the extrusion of the seasoning, thus causing inconvenience to users.

### DISCLOSURE OF THE INVENTION

Therefore, the present invention has been made in view of the above problems, and it is an object of the present invention to provide a bottle for extruding a fluid seasoning via an extruding pipe supported by a lid and introduced into the bottle in pressing the bottle containing the seasoning, wherein a residue collection concavity for collecting residue is formed on the bottom of the bottle, an air inflow unit for introducing air into the bottle is operated by an air inflow hole formed through the lid and opened/closed by an opening/closing side formed in a packing intermediated between the bottle and the lid, and a lower inlet of the extruding pipe is positioned in the residue collection concavity provided in the same direction as that of an upper extruding outlet.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a bottle for extruding a fluid seasoning in accordance with the present invention;

FIG. 2 is an assembled side view of the bottle for extruding a fluid seasoning in accordance with the present invention;

FIG. 3 is an enlarged cross-sectional view of an air inflow unit of the bottle for extruding a fluid seasoning in accordance with the present invention;

FIG. 4 is a perspective view of another embodiment of an opening and closing side of the bottle for extruding a fluid seasoning in accordance with the present invention; and

FIG. 5 is a partial cross-sectional view of another embodiment of the bottle for extruding a fluid seasoning in accordance with the present invention.

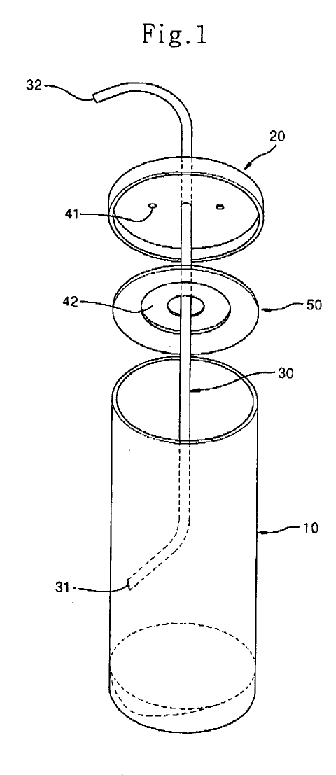

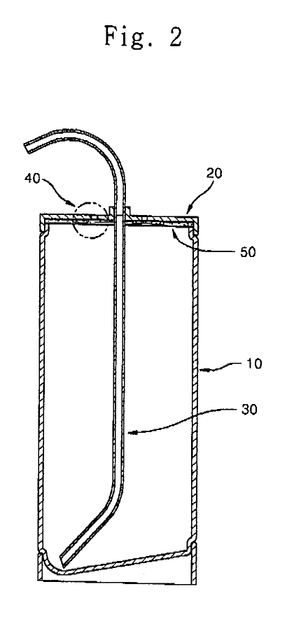

### BEST MODE FOR CARRYING OUT THE INVENTION

Now, preferred embodiments of the present invention will be described in detail with reference to the annexed drawings,

There is provided a bottle 10 for extruding a fluid seasoning (hereinafter, referred to as “contents”) selected from various types via an extruding pipe 30 supported by a lid 20 and introduced into the bottle 10 in pressing the bottle 10 containing the contents, wherein a residue collection concavity 11 for collecting residue toward at a tilted side in extruding is formed on the bottom of the bottle 10, an air inflow unit 40 for introducing air into the bottle is operated by an air inflow hole 41 formed through the lid 20 and opened/closed by an opening/closing side formed in a packing 50 intermediated between the bottle 10 and the lid 20, and a lower inlet 31 of the extruding pipe 30 is positioned in the residue collection concavity 11 provided in the same direction as that of an upper extruding outlet 32.

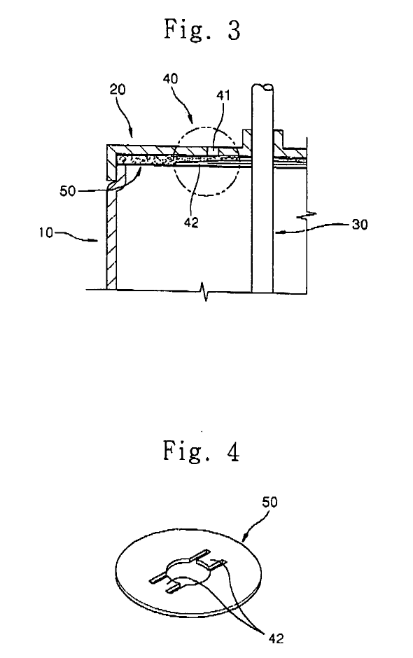

In this embodiment of the present invention, the bottle 10 is made of a thermoplastic synthetic resin (such as polyethylene, vinyl chloride, carbonate polyamide, etc.) by molding. As shown in FIG. 3, the inner circumference of the ring-shaped packing 50 mounted in the air inflow unit 40 in order to seal off the bottle 10 and the lid 20 is extended toward the bottom surface of the air inflow hole 41 formed through the lid 20 so that the extended portion thereof becomes an opening/closing side 42. The opening/closing side 42 is thinner than other portion so that the opening/closing operation is smooth. In another embodiment, as shown in FIG. 4, both edges of the sides of the opening/closing side 42 are cut so that the opening/closing operation is smoother.

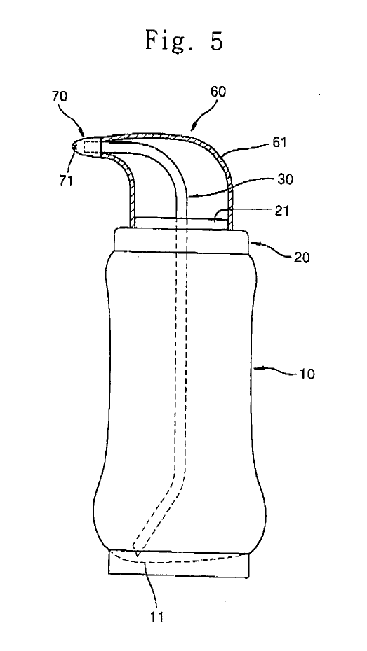

In still another embodiment, in order to decorate the appearance of the bottle by coating the extruding pipe 30 thereon, as shown in FIG. 5, an ornamental cap 60 is inserted into a protrusion 21 formed on the lid 20 and the upper portion is attached to the inside of the cap 60. Herein, the ornamental cap 60 includes a ventilation hole 61 for supplying air. A nozzle 70 made of a flexible material such as rubber and provided with a cross-shaped opening formed at the end of the nozzle 71 is inserted into the upper extruding outlet 32 of the extruding pipe 30, so that the opening is expanded by pressure generated in extruding the contents.

### INDUSTRIAL APPLICABILITY

As apparent from the above description, the bottle of the present invention comprises the air inflow unit 40, thus by introducing air into the bottle 20 the air inflow unit 40 provided separately from the extruding pipe 30 when after the contents are extruded into the front end of the extruding pipe 30 by pressing the bottle and then user's hands are released from the pressed portion. Accordingly, the bottle is easily and rapidly swollen and the re-extruding of the bottle is easy. Further, since the introduced air is introduced into the air inflow unit 40 regardless of the extruding pipe 30, the bottle can easily extrude the contents even by slightly pressing the bottle under the condition that the extruding pipe 30 is almost completely filled with the contents.

Since the upper extruding outlet 32 and the residue collection concavity 11 for collecting residue toward at the tilted side of the bottle 10 are formed on the bottom of the bottle 10, and the lower inlet 31 of the extruding pipe 30 is positioned in the residue collection concavity 11, the residual contents in the bottle 10 are collected in the bottom end of the extruding pipe 30 and then easily exhausted to the outside.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A bottle for extruding a fluid seasoning via an extruding pipe supported by a lid and introduced into the bottle in pressing the bottle containing the seasoning,
wherein a residue collection concavity for collecting residue is formed on the bottom of the bottle, an air inflow unit for introducing air into the bottle is operated by an air inflow hole formed through the lid and opened/closed by an opening/closing side formed in a packing intermediated between the bottle and the lid, and a lower inlet of the extruding pipe is positioned in the residue collection concavity provided in the same direction as that of an upper extruding outlet.

2. The bottle for extruding a fluid seasoning as set forth in claim 1, wherein both edges of the sides of the opening/closing side are cut so that the opening/closing operation is smooth.

3. The bottle for extruding a fluid seasoning as set forth in claim 1, wherein the lid includes an ornamental cap inserted into a protrusion formed on the lid and provided with a ventilation hole so that the ornamental cap covers the extruding pipe protruded from the upper surface of the lid.

4. The bottle for extruding a fluid seasoning as set forth in claim 1, wherein a nozzle made of a flexible material such as rubber and provided with a cross-shaped opening formed at the end of the nozzle is inserted into the upper extruding outlet of the extruding pipe.
